(19) United States
(12) Patent Application Publication
(10) Pub. No.: US 2026/0188120 A1
(43) Pub. Date: Jul. 2, 2026

(54) Merging of Connected and Automated Vehicles Using Control Barrier Function

(71) Applicant: Southwest Research Institute, San Antonio, TX (US)

(72) Inventors: Mrdjan Jankovic, Birmingham, MI (US); Shresta Rajakumar Deshpande, San Antonio, TX (US)

(21) Appl. No.: 19/002,838

(22) Filed: Dec. 27, 2024

(51) Int. Cl. G08G 1/00; B60W 30/18; H04W 4/44

(52) U.S. Cl. CPC G08G 1/22; B60W 30/18163; H04W 4/44

(57) ABSTRACT

A system for directing merging of CAVs (connected and automated vehicles) approaching a merge point, without explicit ordering. Each CAV has an on-board merge agent controller, which communicates with a merge manager process. The communicated data comprises data to the merge manager process representing that CAV's mass, reference velocity, and location, and data from the merge manager process representing a commanded velocity. The merge manager process determines a commanded velocity for each CAV by solving a cost function subject to control barrier constraints with velocity as the control variable.

### FEDERALLY SPONSORED RESEARCH AND DEVELOPMENT

This invention was made with government support under Contract No. DE-AR0000837 awarded by the United States Department of Energy ARPA-E. The government has certain rights in the invention.

### BACKGROUND OF THE INVENTION

Merging points (such as on freeway entrance and exit ramps) are major bottlenecks of road networks, resulting in congestion and accidents. They are a source of stress for many drivers. To address this problem, control strategies for automated merging have attracted significant attention. Most approaches to merge control consider short-merge scenarios, in which vehicles are considered to move “on rails” and steering is not used for avoidance and negotiation.

Short-merge policies can be broadly divided into the following categories: Priority-based “request-reply”, First-In-First-Out (FIFO), and planning-based methods. Each of these merge control methods attempts to explicitly order vehicles through the merge point. In such approaches, continuity of the resulting policy is often a concern. Further, none of these policies consider the mass (size) of the vehicles to optimize the energy efficiency aspect of the resulting merging maneuvers. Consequently, these approaches lead to a simplistic treatment of the impact of merging controls on the system-level energy consumption.

### BRIEF DESCRIPTION OF DRAWINGS

FIG. 1 illustrates a system for controlling merging of vehicles at a merge point.

### DETAILED DESCRIPTION OF THE INVENTION

The following description is directed to a method for energy-efficient, collision-free merging of Connected and Automated Vehicles (CAVs) using Control Barrier Functions (CBFs). The CBF-based merging method computes a continuous and unordered policy i.e., negotiations and merging maneuvers are performed without assigning vehicles an explicit order. A distinctive feature of this method is the consideration of the mass (size) of the vehicle in the optimization routine for safe and economic merging in mixed traffic.

As used herein, connected and autonomous vehicles (CAVs) are vehicles that use a combination of technologies to assist or replace the driver. They use advanced sensors, GPS, telecommunications, on-board controllers, and remote processing capabilities. They have a control system for their propulsion and braking systems, often referred to as a “longitudinal control system”. Of particular interest to this description is that a CAV's control system provides the CAV with velocity instructions, referred to herein for merge management purposes as that CAV's “reference velocity”.

Control barrier functions (CBFs) are familiar in the field of obstacle avoidance. CBF-based approaches ensure system safety and good real-time performance by imposing additional constraints on the system control inputs, ensuring that the system trajectory remains within a safety set.

The method described herein may be referred to as a “CBF-based merge method”. The objective of the method is to improve the efficiency of merges for CAVs approaching a merge of two or more lanes of traffic. The method uses CBFs to completely avoid ordering and to assure collision avoidance. Liveness, i.e. smooth flow without gridlocks, comes from inter-agent instability. The method may be also considered to be an “eco-merge method” in that like “eco driving”, it involves vehicle behaviors that can result in reduced energy consumption.

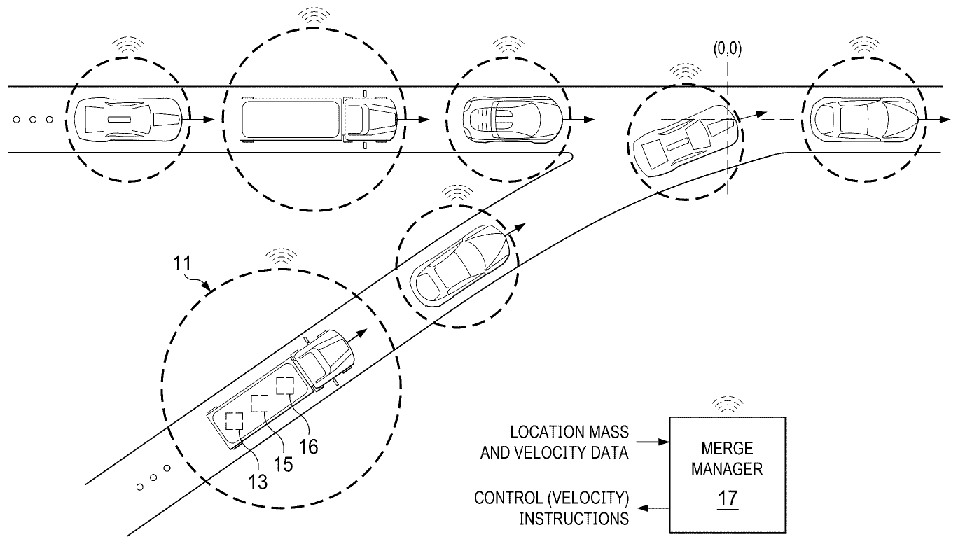

FIG. 1 illustrates a number of CAVs 11 (herein also referred to as agents) in an area of interest (control zone) near a merge point. The CAVs are approaching the merge point and attempting to merge from separate lanes of traffic into a single lane at the merge point. As shown, CAVs 11 are of different sizes and have differing masses. They may be traveling at different velocities. As stated above, by definition, each CAV 11 is assumed to have the associated equipment for driverless navigation. It is assumed that each CAV's control system is capable of keeping that CAV in its traffic lane. However, as explained below, while the CAV is in the merge zone and commanded by the merge process described herein, steering does not play a role in collision avoidance or in establishing a merge order—the CAVs accelerate or decelerate to avoid collision.

It is further assumed that each CAV 11 is equipped with a V2I communications device 13. “V2I” communication stands for “Vehicle-to-Infrastructure” communication, which refers to the wireless exchange of data between vehicles and roadside infrastructure. V2I communications are conventionally used for communication with infrastructure such as traffic lights, road signs, and lane markings.

For purposes of this description, V2I allows each CAV 11 to communicate with a merge manager 17, a process that controls the merge behavior of CAVs 11 within a control zone. It is assumed that merge manager 17 is implemented with appropriate on-board hardware and software for carrying out these tasks and for implementing the method described herein.

In the embodiment of FIG. 1, merge manager 17 is located “at the edge”, such as near the merge intersection. “At the edge” control is used herein in its conventional sense, that is, control in which traffic management decisions are made and implemented locally, using data collected near the specific location rather than by sending data to a remote location. Merge manager 17 may be part of a more comprehensive intersection management system.

Merge manager 17 may be “centralized” in the sense that it processes and directs the CAVs as they merge. In other embodiments, the method may be implemented as a distributed system with each agent performing merge processing and equipped with V2V communications. In a distributed system, each CAV would have its own on-board merge manager process 17.

Each CAV 11 is equipped with an on-board merge agent controller 15. It is assumed that merge controller 15 has appropriate on-board hardware and software for carrying out these tasks and for implementing the method described herein.

While a CAV 11 is in the merge zone, its controller 15 provides that CAV's location, mass, and reference velocity data to merge manager 17 via V2I communications device 13. As indicated above, the “reference velocity” is the velocity at which that CAV's control system would instruct the CAV to travel in the absence of a merge commanded velocity generated by the merge management system described herein.

While a CAV 11 is in the merge zone, its controller 15 also receives “merge commanded velocity” data for that vehicle via the V2I device 13 from merge manager 17. A “merge commanded velocity” is the velocity the merge manager 17 determines is appropriate for this CAV to handle the merge safely. Controller 15 delivers these merge commanded velocity instructions to its CAV's vehicle propulsion and braking systems as appropriate.

Each CAV 11 also has an on-board GPS device 16 that acquires and communicates its location data to merge manager 17 via V2I communications device 13. The CAV's mass data is known and stored a priori by controller 17.

The data delivered from each CAV 11 to merge manager 17 (velocity, location, and mass (or equivalently, size) is delivered at a pre-defined rate while that CAV is in the merge zone. An example of a suitable data delivery rate is 50 ms. Both the reference velocity and the merge commanded velocity are updated during the merge management process as explained below.

Merge manager 17 is programmed to model each agent (CAV) 11 in the control zone [0019] with a holonomic single integrator. In the CBF-based method described herein, velocity is the control input. Using velocity as the control variable improves liveness (i.e., merge speed). This is in contrast to other merge control approaches that use double integrator models with an agent's acceleration as the control variable. Although velocity is the control variable, acceleration is limited by a restriction on the rate of change of velocity between consecutive updates.

As explained below, merge manager 17 is further programmed to perform a CBF-based merging method that computes an unordered policy. In other words, merging maneuvers are performed without assigning CAVs an explicit order. New arrival of a CAV into the control zone may change the (implicit) merge order of those downstream.

In mathematical terms, each CAV (agent) i is modeled as a convex shape, such as a disk or ellipse, described by a center and a radius. Here, each agent is represented as a disk of radius rⁱ, whose center motion is given by:

$${\dot{s}}_{t}^{i} = {v}_{t}^{i} = {u}_{t}^{i} , ∀ i = 1 , … , {N}_{a} , where {s}_{t}^{i}$$

is the distance of agent i at time t from the merge point, uₜⁱ is its control action and Nₐ is the number of agents in the network. The X and Y components of the velocity

$${v}_{t}^{i} are \{ {v}_{t}^{i x} , {v}_{t}^{i y} \}$$

respectively and are computed using the road geometry and the agent's motion.

Based on this model of each CAV, center-to-center separations between pairs of CAVs are calculated. The relative motion between two agents i and j is given by:

$${\dot{ξ}}_{t}^{i j} = {v}_{t}^{i j} , where {ξ}_{t}^{i j} = {[ {x}_{t}^{i} - {x}_{t}^{j} , {y}_{t}^{i} - {y}_{t}^{j} ]}^{T}$$

is the center-to-center (vector) separation between two agents and

$${v}_{t}^{i j} = {[ {v}_{t}^{i x} - {v}_{t}^{j x} , {v}_{t}^{i y} - {v}_{t}^{j y} ]}^{T}$$

is their relative velocity.

Collision avoidance is assured via enforced constraints based on inter-agent separation and relative velocity. The inter-agent separation, ∥ξₜ^{ij}∥>(1+β)·(rⁱ+r^{j}), where β is the (tunable) radius margin (for added robustness and establishing/maintaining minimal distance). To achieve this, a barrier function is defined as a function of the separations. This barrier function

$${h}_{t} ( {ξ}_{t}^{i j} )$$

is defined with the goal to keep it greater than 0:

$${h}_{t} ( {ξ}_{t}^{i j} ) = {( {ξ}_{t}^{i j} )}^{T} {ξ}_{t}^{i j} - {( ( 1 + β ) \cdot ( {r}^{i} + {r}^{j} ) )}^{2} .$$

A barrier constraint is calculated for each pair of CAVs based on the barrier function and velocities. Additionally, constraints are applied to the control variables for realism and comfort (such as acceleration limits). The following first-order CBF barrier constraint is constructed (the barrier constraint must be affine in control):

$${F}_{t}^{i j} := {\dot{h}}_{t} ( {ξ}_{t}^{i j} ) + λ {h}_{t} ( {ξ}_{t}^{i j} ) \geq 0$$

$${A}_{t}^{i j} {u}_{t}^{i j} + {B}_{t}^{i j} \geq 0$$

where λ is the (tunable) barrier bandwidth,

$${A}_{t}^{i j} = 2 \cdot {( {ξ}_{t}^{i j} )}^{T} and {B}_{t}^{i j} = λ \cdot {h}_{t} ( {ξ}_{t}^{i j} ) .$$

Each pair of agents generates one constraint. Note that

$${u}_{t}^{i j} = {v}_{t}^{i j}$$

comprise the x and y components of the relative CAV velocities, which depend on the geometry of merging roads.

A cost function is based on a CAV's deviation from a reference speed and the rate of change in its commanded velocity, weighted by its mass (summed for all CAVs in the control zone). The cost function with its constraints is formulated as follows:

$${min}_{{u}_{k}^{1} , … , {u}_{k}^{{N}_{a}}} {\sum }_{i = 1}^{{N}_{a}} {‖ {u}_{k}^{i} - {v}_{k 0}^{i} ‖}^{2} + {m}_{v e h}^{i} \cdot {‖ {u}_{k}^{i} - {u}_{k - 1}^{i} ‖}^{2}$$

$$subject to {A}_{k}^{i j} {u}_{k}^{i j} + {B}_{k}^{i j} \geq 0 , ∀ i , j = 1 , … , {N}_{a} , i \neq j$$

where k denotes the discrete time instant corresponding to current time t=kTₛ (where Tₛ is the sampling time,

$${v}_{k 0}^{i}$$

is the reference velocity or the vehicle i,

$${m}_{v e h}^{i}$$

denotes the mass of the vehicle i, and

$$\{ {A}_{k}^{i j} , {B}_{k}^{i j} \}$$

are terms from the CBF-based constraints. The first term in the objective function penalizes deviation from the reference speed, while the second penalizes the rate of change of each vehicle's speed (effectively, acceleration). The value

$${u}_{k - 1}^{i}$$

is the commanded velocity for the CAV i computed in the previous time instant (k−1)Tₛ. In addition, one can have a separate set of constraints for upper and lower acceleration limits:

$${a}^{min} \leq \frac{{u}_{k}^{i} - {u}_{k - 1}^{i}}{{T}_{s}} \leq {a}^{max} .$$

The merge manager process 17 finds the set of controls

$${u}_{k}^{1} , … , {u}_{k}^{{N}_{a}}$$

that minimizes the cost function subject to the formulated constraints, thereby simultaneously generating the optimal commanded velocities for all the CAVs in the merge zone. The cost function may be solved using standard convex optimization methods. An example of a suitable optimization method is qpOASES, which is a commercially available product that can be used to solve convex quadratic programming problems. However, other quadratic programming solvers can be used for this optimization problem.

The resulting merging policy provides continuous control actions. It controls all the CAVs in the control zone without assigning them an explicit order.

A distinctive feature of the CBF-based merge management system described above is the consideration of the mass (size) of the agents in the cost function (second term) of the optimization routine for safe and economic merging. This enables its use in mixed traffic-containing light, medium and/or heavy-duty vehicles. Process 17 computes and applies lower accelerations for vehicles with larger mᵥₑₕ.

A further advantage of the above-described merge management system is that it results in faster merge negotiations compared to conventional acceleration-based methods. Specifically, the positive (unstable) eigenvalue of the velocity-based controller is significantly higher than its acceleration-based counterpart, resulting in greater liveness for merging. Penalizing the rate of change in the velocity ensures smooth merging that is energy-efficient, while penalizing deviation from the reference velocity ensures that the commanded merge velocity is close to the reference velocity.

Another feature of this merge method is that it can be integrated with existing longitudinal velocity controllers (such as eco-driving controls) as a safety filter that adds cooperative merging capability.

### Experimental Results

The above-described CBF-based merge method (having velocity as the control variable) was compared in Monte Carlo simulations to a conventional FIFO merge method with acceleration as the control variable and having a second-order CBF barrier constraint. For this evaluation, 20 agents were considered, 10 each on the highway and merge lanes. Vehicle masses were selected randomly with uniform distribution between two extremes. Target dyno coefficients were obtained for these vehicles from an Environmental Protection Agency document. Desired speeds for the vehicles were selected randomly between 20 and 25 m/s (approximately 45 and 55 mph).

In these simulations, the CBF/velocity-based merge method of this description improved system-wide performance across all the key evaluation metrics, compared to the FIFO merge method. The mean/median BE, a measure of energy losses from braking, was reduced by 14 and 18% respectively. The mean nTEL, that captures total energy losses, was reduced from 243 Wh/km (FIFO) to 231 Wh/km i.e., by 5% (while median nTEL was reduced by approximately 7%). Additionally, it reduced system congestion, evidenced by travel time results.

A particular finding from the Monte Carlo simulations, profiles of agent velocities, illustrated the difference between the CBF/velocity-based and conventional FIFO merge methods. In the FIFO scheme, the order in which the agents merge is solely determined by their distance from the merge point at the time they enter the control zone-only agents having (relatively) higher priority are considered while formulating collision constraints for an agent. As a result, FIFO methods do provide orderly merge sequences. On the other hand, there were several instances observed where a heavier vehicle traveling at a higher speed was forced to brake for a lighter, slower vehicle. This adversely affects system-wide energy consumption. Additionally, such slowdowns propagate as the number of agents increases, thereby further increasing travel time. In contrast, the unordered control policy from the CBF/velocity-based merge method enables implicit ordering between all the agents in the network due to a higher penalty on changing velocities of heavier vehicles, and the result is smaller magnitude of velocity changes at a system-level. An interesting behavior exhibited by the agents of this method (not seen in FIFO) is that some lighter agents accelerate prior to the merge point to reduce the velocity drop (and consequent energy transactions) experienced by the following (heavier) agents.

1. A system for directing merging of CAVs (connected and automated vehicles) in an area of interest (control zone) in different lanes of traffic and approaching a merge point, the CAVs having masses and reference velocities and having a longitudinal control system, comprising:
a merge agent controller on board each CAV, programmed to communicate with a merge manager process while the CAV is in the control zone, with communicated data being data delivered to the merge manager process representing that CAV's mass, reference velocity, and location, and data received from the merge manager process representing a commanded velocity, the merge agent controller being further programmed to deliver the commanded velocity to that CAV's longitudinal control system; and
a merge manager process programmed to perform the following tasks to determine a commanded velocity for each CAV in the control zone: to model each CAV in the control zone as a convex shape; compute separations between pairs of CAVs based on the model of each CAV; to define a control barrier function as a function of the separations; to calculate a barrier constraint for each pair of CAVs based on the control barrier function and applied to their commanded velocities as a control variable; to define a cost function comprising each CAV's deviation from its reference velocity and the rate of change in its commanded velocity, weighted by its mass; and to determine a set of commanded velocities that minimizes the cost function subject to the barrier constraints, thereby simultaneously generating a commanded velocity for each CAV.

2. The system of claim 1, wherein the merge manager process is located near the merge point.

3. The system of claim 1, wherein the CAVs have varying masses.

4. The system of claim 1, wherein the CAVs have varying reference velocities.

5. The system of claim 1, wherein the commanded velocities do not result in an explicit order of the CAVs.

6. The system of claim 1, wherein each CAV is equipped with a GPS device for providing the location data.

7. The system of claim 1, wherein the communicated data is communicated at a predefined rate.

8. A distributed system for directing merging of CAVs (connected and automated vehicles) in an area of interest (control zone) in different lanes of traffic and approaching a merge point, the CAVs having masses and reference velocities and having a longitudinal control system, comprising:
a merge agent controller on board each CAV, programmed to communicate with a merge manager process while the CAV is in the control zone, with communicated data being data delivered to the merge manager process representing that CAV's mass, reference velocity, and location, and data received from the merge manager process representing a commanded velocity, the merge agent controller being further programmed to deliver the commanded velocity to that CAV's longitudinal control system; and
a merge manager process on board each CAV, each merge manager process programmed to perform the following tasks to determine a commanded velocity for each CAV in the control zone: to model each CAV in the control zone as a convex shape; compute separations between pairs of CAVs based on the model of each CAV; to define a control barrier function as a function of the separations; to calculate a barrier constraint for each pair of CAVs based on the control barrier function and applied to their commanded velocities as a control variable; to define a cost function comprising each CAV's deviation from its reference velocity and the rate of change in its commanded velocity, weighted by its mass; and to determine a set of commanded velocities that minimizes the cost function subject to the barrier constraints, thereby simultaneously generating a commanded velocity for each CAV.
